(19) United States
(12) Patent Application Publication
(10) Pub. No.: US 2009/0083503 A1
(43) Pub. Date: Mar. 26, 2009

(54) SYSTEM OF CREATING LOGICAL VOLUME AND METHOD THEREOF

(75) Inventors: Lei LI, Tianjin (CN); Lei He, Tianjin (CN); Tom Chen, Taipei (TW); Win-Harn Liu, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei City (TW)

(21) Appl. No.: 11/858,319

(22) Filed: Sep. 20, 2007

(51) Int. Cl. G06F 12/16

(52) U.S. Cl. 711/162; 711/E12.103

(57) ABSTRACT

A system of creating logical volume and method thereof is used to solve the problems such as creation steps are complicated, a space of storage medium is wasted and the number of snapshots to be created is limited. An available logical volume space and a timestamp storage area are allocated in the logical volume according to space allocation algorithm. According to original data and data amended at subsequent time point in the logical volume, copy-on-write operation is sequentially performed on the amended data in the logical volume to create a timestamp corresponding to the time point. The timestamp of the corresponding time point is stored in the timestamp storage area. A storage medium offset address pointer is created to record writing position of the copy-on-write operation of the corresponding time point. And the pointer is stored in the storage medium to serve as index information of address of each timestamp.

### BACKGROUND

1. Field of Invention

The present invention relates to a storage technology, and more particularly to a system of creating a logical volume and a method thereof.

2. Related Art

In order to ensure the safety of user data with high efficiency and order, various storage technologies have been proposed till now, such as redundant array of disks (RAID) and logical volume manager (LVM). The LVM has the characteristic of creating a device snapshot, and the snapshot may instantly back up the data in the logical volume of the LVM at a specific time point and has little influence on the efficiency of image data service. Currently, the LVM of the conventional art proposes a snapshot dependent technology, i.e., an old snapshot exists depending on a newly created snapshot, and the data of a volume group amended by a user is only backed up in the snapshot that is created latest, thereby efficiently avoiding the waste of the space of a storage medium and significantly lightening the load of reading and writing the storage medium, such as a disk.

However, in the snapshot dependent technology, since an old snapshot always exists depending on a newly created snapshot, the deletion of a snapshot is limited to some extent. In other words, only the oldest snapshot is allowed to be deleted; otherwise, all the snapshots created before the deleted snapshot will be damaged.

FIG. 1 is a flow chart for the LVM in the conventional art to create a snapshot. Referring to FIG. 1, the creating procedures and defects of the snapshot dependent technology of the LVM of the conventional art are illustrated.

As shown in FIG. 1, a snapshot creating command is parsed firstly to determine whether the logical volume appointed in the snapshot creating command really exists, i.e., determine whether the format of the snapshot creating command is correct (Step 102). If the format of the command is incorrect, an error message may be sent out directly and the system is exited from. If the format of the command is correct, the usage situation of all physical blocks of the volume group is read from the disk (Step 104). Then, it is verified whether the volume group has a sufficient free space (Step 106), and if the free space is insufficient, an error message may be sent out and the system is exited from. If the free space is sufficient, according to the usage situation of the current physical blocks and a space allocation algorithm, an available space with a requested size is allocated for the logical volume or the snapshot, and physical blocks required by the snapshot are allocated (Step 108). Finally, the information of the snapshot is recorded in a memory and the changes of the snapshot and the allocation situation of the physical blocks are written into the disk (Step 110).

The method of the conventional art still has many problems as follows. 1. The process logic is quite complicated, and especially when there are a lot of requests for reading and writing data, it will take long time to create snapshots. 2. Each snapshot occupies an independent disk space, and therefore, when one logical volume stores a plurality of snapshots, only the last snapshot may back up data, and the others do not allow data to be written on the disk. Therefore, although disk spaces have been allocated for these snapshots as created, the disk spaces are full used, thereby wasting the space. 3. In the current LVM architecture, the snapshot must be created by a user manually at a specific time point, and when the data is to be restored, the time points that can be selected by the user are limited and not suitable for consecutive and efficient user data protection. 4. Since the copy-on-write information of the snapshot occupies a lot of memory, the total number of the snapshots that can be created in a system is limited by the LVM architecture of the conventional art, so as to ensure the stability and availability of the system. 5. In the LVM architecture of the conventional art, it is difficult to ensure that the snapshot data in the same logical volume may be continuously stored on a logical storage device, thereby making it troublesome to back up snapshot data based on a block device layer.

### SUMMARY OF THE INVENTION

In order to solve the aforementioned problems and defects in the conventional art, the present invention is directed to provide a system of creating a logical volume and a method thereof, so as to solve the problems in the conventional art such as the creation steps are complicated, the space for a disk is wasted, and the number of the snapshots to be created is limited.

The system of creating a logical volume provided by the present invention includes an allocation module, a timestamp creating module, a timestamp storage module, and a pointer module. Herein, the allocation module allocates an available logical volume space and a timestamp storage area in a logical volume according to a space allocation algorithm. The timestamp creating module backs up original data of the logical volume, so that a first timestamp is created when data is input to or output from the logical volume for the first time and according to one or more time points of amending the original data of the logical volume, sequentially perform copy-on-write operation on the amended data in the logical volume at corresponding time points, so as to create timestamps corresponding to the amendment time points. The timestamp storage module continuously stores the first timestamp and the timestamps of the corresponding amendment time points in the timestamp storage area. The pointer module creates a storage medium offset address pointer for recording writing positions of the copy-on-write operation at the corresponding amendment time points, so as to serve as index information of addresses of the timestamps. The pointer points to an initial address of the timestamp storage area before the first timestamp is created, and sequentially moves backward with the creation of the timestamps of the amendment time points.

The method of creating a logical volume provided by the present invention includes: allocating an available logical volume space and a timestamp storage area in the logical volume according to a space allocation algorithm; backing up original data of the logical volume when data is input to or output from the logical volume for the first time, so as to create a first timestamp; according to one or more time points of amending the original data of the logical volume, sequentially performing copy-on-write operation on the amended data of the logical volume at the amendment time points, so as to create timestamps corresponding to the amendment time points; continuously storing the first timestamp and the timestamps of the corresponding amendment time points in the timestamp storage area; creating a storage medium offset address pointer for recording writing positions of the copy-on-write operation at the corresponding amendment time points; and storing the pointer in a storage medium, so as to serve as index information of addresses of the timestamps. The pointer points to the initial address of the timestamp storage area before the first timestamp is created, and sequentially moves backward with the creation of the timestamps of the amendment time points.

In an embodiment of the present invention, a logic storage space is additionally allocated when the logical volume is created, so as to continuously store the backup data of amendments at the specific time points in the logical volume, i.e., the timestamps. The index information of the address of each timestamp is created according to the storage medium offset address pointer for recording the writing position of the current copy-on-write operation, thereby obtaining the backup of the amended data in the logical volume at the corresponding time points using the pointer. Therefore, the present invention significantly simplifies the steps of creating the timestamps and avoids the process of reading the storage medium and allocating spaces when the storage medium receives many input/output requests, thereby efficiently solving the problem that the process of creating a snapshot is time-consuming when many requests of reading and writing data are sent.

Furthermore, since the creation of the timestamps consumes less, a timestamp may be added separately for each copy-on-write operation upon user's requirements, i.e., create a separate snapshot for each writing request. Therefore, the user is allowed to fully protect the data at any time point. Since the corresponding copy-on-write data is recorded at each time of writing operation, in the present invention, redundant copy-on-write data is transferred between the memory and the storage medium, thereby controlling the total space in the memory occupied by the copy-on-write data and solving the problem that the total number of the snapshots to be created is limited.

Finally, in the present invention, the timestamps of the same logical volume are all in a storage area, so as to simplify the process logic of backing up and restoring data, so that not only maintenance becomes convenient, but also such a mechanism of continuously storing backup data reduces the waste of the storage medium space to some extent.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a flow chart for the LVM of the conventional art to create a snapshot;

FIG. 2 is a systematic block diagram of the system of creating a logical volume according to the present invention;

FIG. 3 is a flow chart of creating a logical volume according to the present invention;

FIG. 4 is a flow chart of the steps for the logical volume of the present invention to back up data by using the timestamp storage area; and

FIG. 5 is a schematic view of the layout of backing up data in the timestamps of the logical volume according to the present invention.

### DETAILED DESCRIPTION OF THE INVENTION

The features and practices of preferred embodiments of the present invention will be illustrated below in detail with reference to the drawings.

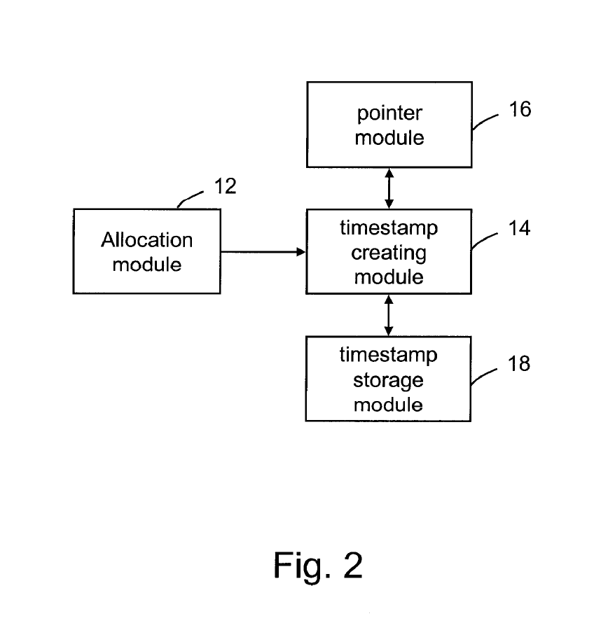

Referring to FIG. 2, a system of creating a logical volume provided by the present invention is shown. The system includes an allocation module 12, a timestamp creating module 14, a timestamp storage module 18, and a pointer module 16. The allocation module 12 allocates an available logical volume space and a timestamp storage area in the logical volume according to a space allocation algorithm. The timestamp storage area herein may be a snapshot pool, a storage pool, and the like. The timestamp storage area may be a small space which is allocated in the same manner as that adopted in the LVM of the conventional art to create a logical volume or a snapshot. One timestamp storage area may be created when the logical volume is created, and allocated with a specific space.

The timestamp creating module 14 is used to create data backup of the logical volume at a certain time point, which is referred to as a timestamp. For example, the original data of the logical volume is backed up when data is input to or output from the logical volume for the first time, so as to create a first timestamp, and for example, according to the time points of amending the original data of the logical volume, copy-on-write is sequentially performed on the data in the logical volume data which is amended at this time point, so as to create a timestamp corresponding to the amendment time point. The timestamp visually shows the data in the logical volume at a specific time point. The timestamp storage module 18 continuously stores the first timestamp and the timestamps of the corresponding amendment time points in the timestamp storage area. For example, when the original data in the logical volume is amended by the user, amended chunk data of the logical volume is sequentially backed up in the timestamp storage area, that is, the copy-on-write operation merely is performed to back up the amended chunk data in the timestamp storage area. At this point, all the timestamps in the same logical volume are continuously stored in the timestamp storage area.

The pointer module 16 creates a storage medium offset address pointer for recording one or more writing positions of the copy-on-write operation at the corresponding amendment time points, so as to serve as index information of address of each timestamp. The pointer points to an initial address of the allocation space of the timestamp storage area before the first timestamp is created, and sequentially moves backward with the amendment time points and the creation of the timestamps for backing up data. Therefore, each time when the timestamp is created, the pointer module 16 stores the copy-on-write pointer in the storage medium as the index information of address of each timestamp, and furthermore, the data following the address is the backup of the amended data in the logical volume after this time point.

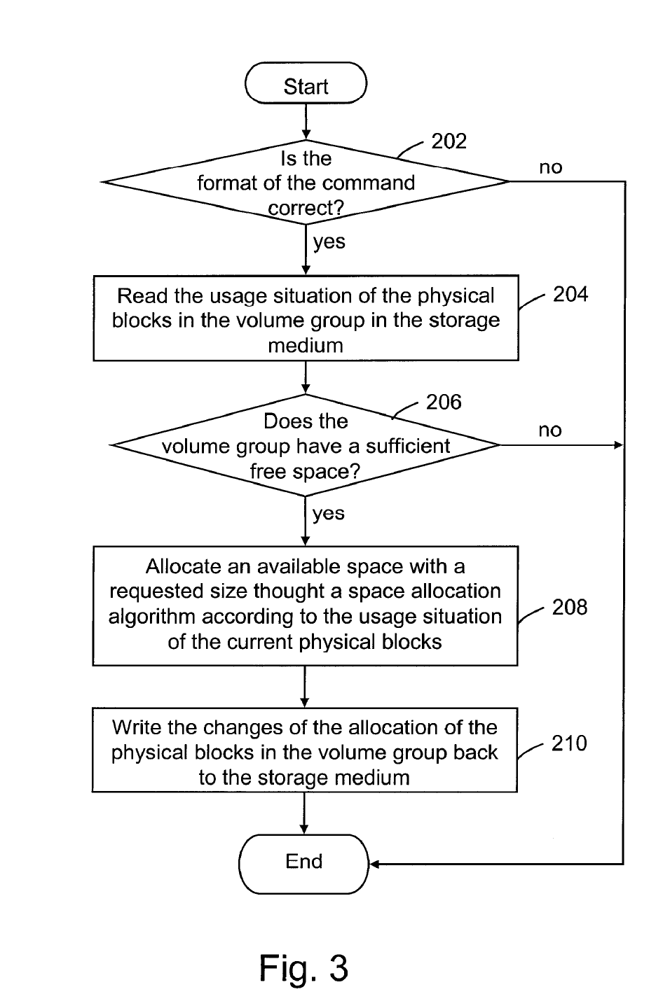

Referring to FIG. 3, a flow chart of creating a logical volume according to the present invention is shown.

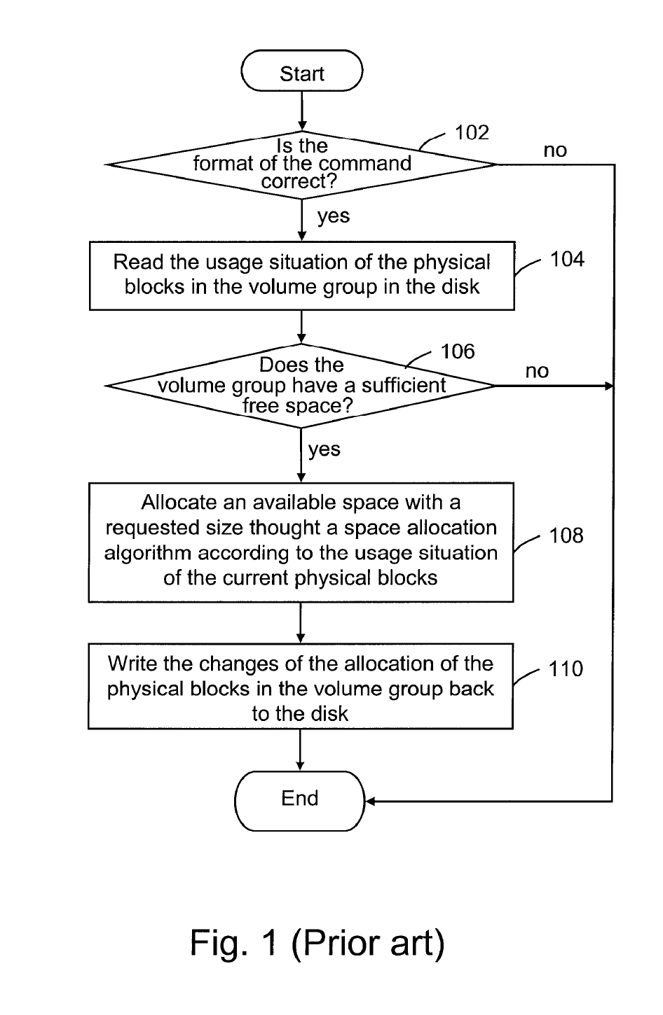

As shown in FIG. 3, except that Step 208 is different from Step 108 in FIG. 1, Steps 202, 204, 206, and 210 are all the same as those in FIG. 1. Therefore, only Step 208 is illustrated and the other steps will not be repeated here.

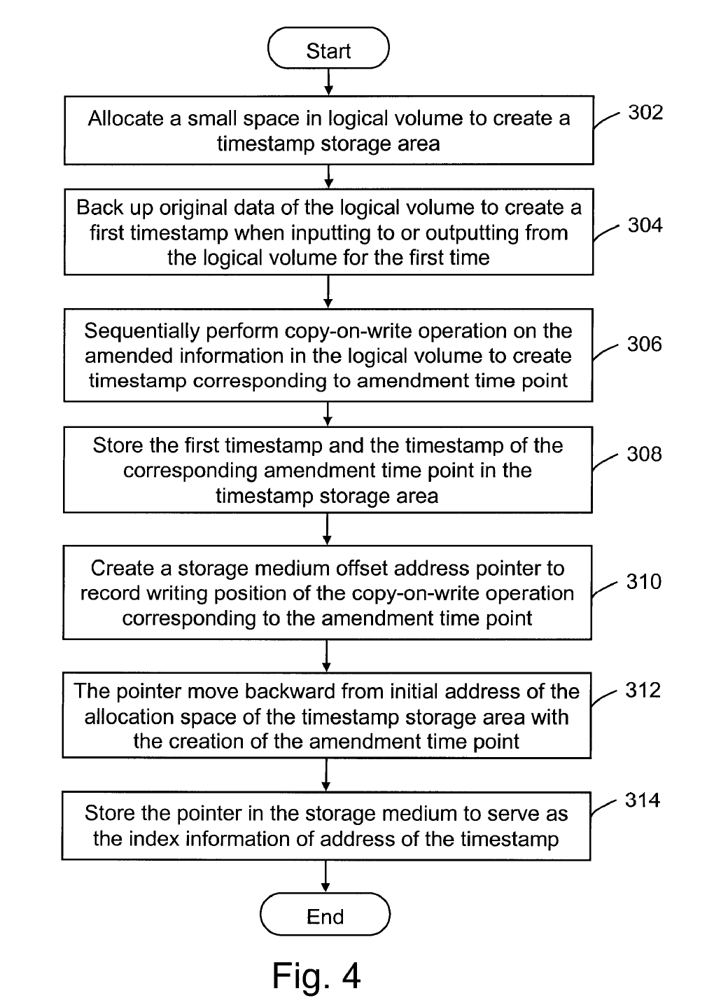

Step 208 is about the space allocation when creating the logical volume, i.e., the logical volume or the snapshot is allocated with an available space and a timestamp storage area with a requested size according to the usage situation of the current physical blocks and the space allocation algorithm (Step 208). Compared with the step of creating the logical volume in the conventional art shown in FIG. 1, in the present invention, an additional space is requested when creating the logical volume. The process of creating the logical volume of the present invention will be illustrated below by referring to FIG. 4.

FIG. 4 is a flow chart of the steps for the logical volume of the present invention to back up data in the timestamp storage area. Firstly, a small space is allocated in the logical volume according to a space allocation algorithm, so as to create a timestamp storage area (Step 302). The timestamp storage area may be a snapshot pool, a storage pool, and the like. The space allocation manner of the timestamp storage area is the same as that applied to the LVM of the conventional art to create a logical volume or a snapshot. Then, when data is input to or output from the logical volume for the first time, the original data of the logical volume is backed up, so as to create a first timestamp (Step 304). Herein, the data backup created for the logical volume at a certain time point is referred to as a timestamp, that is to say, the timestamp stores the data in the logical volume at a certain time point. Subsequently, according to the time points of amending the original data in the logical volume, the copy-on-write operation[s] is[/are] sequentially performed on the amended data in the logical volume at the amendment time points, so as to establish the timestamps corresponding to the amendment time points (Step 306). When the original data in the logical volume is amended by the user, the amended chunk data in the logical volume is backed up in the corresponding timestamp, i.e., during the copy-on-write operation, it merely backs up the amended chunk data. The timestamps including the first timestamp and the timestamps of corresponding amendment time points are all stored in the timestamp storage area (Step 308). At this point, all the timestamps in the same logical volume are continuously stored in the timestamp storage area.

When creating the timestamp, the storage medium offset address pointer is created accordingly, so as to record the writing position[s] of the copy-on-write operations corresponding to the amendment time points of the timestamps (Step 310). The pointer points to the initial address of the allocation space of the timestamp storage area before the first timestamp is created, and sequentially moves backward with the amendment time points and the creation of the timestamps for backing up data (Step 312). Therefore, each time when the timestamp is created, the copy-on-write pointer is stored in the storage medium as the index information of the timestamp address (Step 314), and furthermore, the data following the address is the backup of the amended data in the logical volume after this time point.

Since the timestamp created previously always exists depending on the timestamp created later, only the oldest timestamp in the logical volume is allowed to be deleted. The operation flow is as follows. The address pointer of the oldest timestamp stored in the storage medium is cleaned up, and the initial address of the timestamp storage area is amended to be the timestamp adjacent to the oldest timestamp, i.e., the address of the second oldest timestamp.

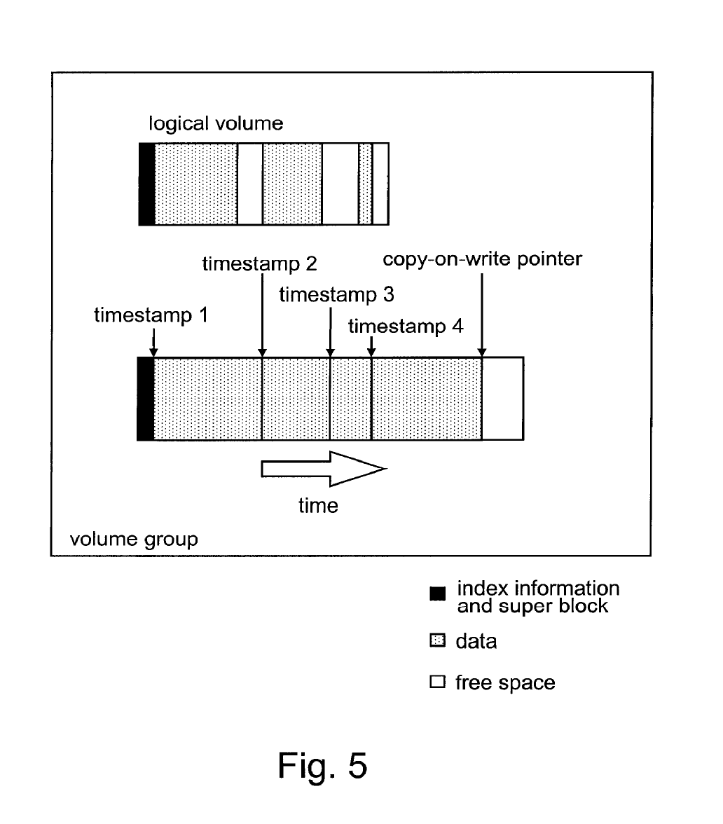

FIG. 5 is a schematic view of the layout of backing up data in the timestamps of the logical volume according to the present invention. As shown in FIG. 5, through the system and method of creating a logical volume provided by the present invention, all the timestamps in the same logical volume are all stored in a storage area collectively and continuously. Therefore, compared with the conventional art in which the separate storage medium space allocated for each snapshot in advance cannot be fully used, the storage of the timestamps in the present invention may reduce the waste of the space of the storage medium, such as a disk, to some extent.

Therefore, the present invention significantly simplifies the steps of creating the timestamps and avoids the process of reading the storage medium and allocating spaces when the storage medium receives many input/output requests, thereby efficiently solving the problem that the process of creating a snapshot is time-consuming when many requests of reading and writing data are sent.

Furthermore, in the present invention, since the creation of the timestamps consumes less, a timestamp may be added separately for each copy-on-write operation upon user's requirements, i.e., create a separate snapshot for each writing request. Therefore, the user is allowed to fully protect the data at any time point. Since the corresponding copy-on-write data is recorded at each time of writing operation, in the present invention, redundant copy-on-write data is transferred between the memory and the storage medium, thereby controlling the total space in the memory occupied by the copy-on-write data and solving the problem that the total number of the snapshots to be created is limited.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system of creating a logical volume, comprising:
an allocation module, for allocating an available logical volume space and a timestamp storage area in the logical volume according to a space allocation algorithm;
a timestamp creating module, for backing up an original data of the logical volume to create a first timestamp when data is input to or output from the logical volume for the first time and according to one or more time points of amending the original data of the logical volume, for sequentially performing one or more copy-on-write operations on the amended data of the data in the logical volume at the corresponding amendment time points to create one or more timestamps corresponding to the amendment time points;
a timestamp storage module, for continuously storing the first timestamp and the timestamps of the corresponding amendment time points in the timestamp storage area; and
a pointer module, for creating a storage medium offset address pointer for recording one or more writing positions of the copy-on-write operations at the corresponding amendment time points to serve as an index information of addresses of the timestamps.

2. The system of creating a logical volume as claimed in claim 1, wherein the pointer points to an initial address of the timestamp storage area before the first timestamp is created, and sequentially moves backward with the creation of the timestamps of the amendment time points.

3. A method of creating a logical volume, comprising:
allocating an available logical volume space and a timestamp storage area in a logical volume according to a space allocation algorithm;
backing up an original data of the logical volume when data is input to or output from the logical volume for the first time to create a first timestamp;
according to one or more time points of amending the original data of the logical volume, sequentially performing one or more copy-on-write operation on the amended data of the data of the logical volume at the amendment time points to create one or more timestamps corresponding to the amendment time points;
continuously storing the first timestamp and the timestamps of the corresponding amendment time points in the timestamp storage area;
creating a storage medium offset address pointer for recording one or more writing positions of the copy-on-write operations at the corresponding amendment time points; and
storing the pointer in a storage medium to serve as index information of addresses of the timestamps.

4. The method of creating a logical volume as claimed in claim 3, wherein the pointer points to an initial address of the timestamp storage area before the first timestamp is created, and sequentially moves backward with the creation of the timestamps of the amendment time points.
